(19) United States
(12) Patent Application Publication
(10) Pub. No.: US 2025/0371475 A1
(43) Pub. Date: Dec. 4, 2025

(54) ADVANCED ML MODELS FOR ENTITY PERFORMANCE PREDICTION AND ENTITY CLASS ANALYSIS

(71) Applicant: Microsoft Technology Licensing, LLC, Redmond, WA (US)

(72) Inventors: Zhongkai LIU, Redmond, WA (US); Lavaleen Kumar JHA, Bothell, WA (US); Umakanth Vithal KORIMILLI, Hyderabad (IN)

(21) Appl. No.: 18/676,500

(22) Filed: May 28, 2024

(51) Int. Cl. G06Q 10/0637; G06F 9/451; G06N 20/00

(52) U.S. Cl. CPC G06Q 10/06375; G06F 9/451; G06N 20/00

(57) ABSTRACT

A computerized method analyzes and presents entity class and performance data. An entity identifier of an entity is received via an entity identifier prompt on a user interface (UI). An icon representing the entity identifier is presented along with current performance data of the associated entity in a portion of the UI associated with a current entity class of the entity. A proposed performance data value for the entity is received and the proposed performance data value is provided to an entity classifier model as input. A proposed entity class is generated using the entity classifier model and based on the proposed performance data value. The icon representing the entity identifier is then automatically moved to a portion of the UI associated with the proposed entity class, whereby the entity can be compared to other entities in the proposed entity class.

### BACKGROUND

Sales planning is an exercise undertaken every fiscal year by many organizations to plan the resources within the operational expenses budget to achieve the financial targets set by organization leadership. It is difficult to use existing computing technology to plan out how the organization can do business in the most optimal manner. For example, plans often have to be revised due to changes in market conditions, based on competitive insights, and other factors. Further, existing solutions lack the ability to dynamically simulate the impact of strategic changes and predict outcomes based on hypothetical scenarios. This limitation hinders the capacity to tailor sales approaches, prioritize efforts, and forecast revenue potential accurately. It is challenging to simplify and improve the operational efficiency of the planning process using existing technological resources, while also maintaining a high level of accuracy in the resulting plans.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for analyzing and presenting entity class and performance data is described. An entity identifier of an entity is received via an entity identifier prompt on a graphical user interface (GUI). An icon representing the entity identifier is presented along with current performance data of the associated entity in a portion of the GUI associated with a current entity class of the entity. A proposed performance data value for the entity is received and the proposed performance data value is provided to an entity classifier model as input. A proposed entity class is generated using the entity classifier model and based on the proposed performance data value. The icon representing the entity identifier is then automatically moved to a portion of the GUI associated with the proposed entity class, whereby the entity can be compared to other entities in the proposed entity class.

Further, a system for analyzing and presenting entity class and performance data is described. An entity identifier of an entity is received via an entity identifier prompt on a GUI. An icon representing the entity identifier is presented along with current performance data of the associated entity in a portion of the GUI associated with a current entity class of the entity. A proposed entity class for the entity is received and the proposed entity class is provided to an entity regressor model as input. A proposed performance data value is generated using the entity regressor model and based on the proposed entity class. The icon representing the entity identifier is then automatically moved to a portion of the GUI associated with the proposed entity class and the proposed performance data value, whereby the entity can be compared to other entities in the proposed entity class.

### BRIEF DESCRIPTION OF THE DRAWINGS

The present description will be better understood from the following detailed description read considering the accompanying drawings, wherein:

FIG. 1 is a block diagram illustrating an example system for generating proposals about aspects of analyzed entities using trained machine learning (ML) models;

FIG. 2 is a block diagram illustrating an example system for training ML models for analyzing customer entity data;

FIG. 3 is a flowchart illustrating an example method for generating proposed performance data values of an entity based on a proposed entity class of the entity;

FIG. 4 is a flowchart illustrating an example method for generating a proposed entity class of an entity based on a proposed performance data value of the entity;

FIG. 5 is a diagram illustrating an example graphical user interface (GUI) for displaying proposed aspects of entities; and

FIG. 6 illustrates an example computing apparatus as a functional block diagram.

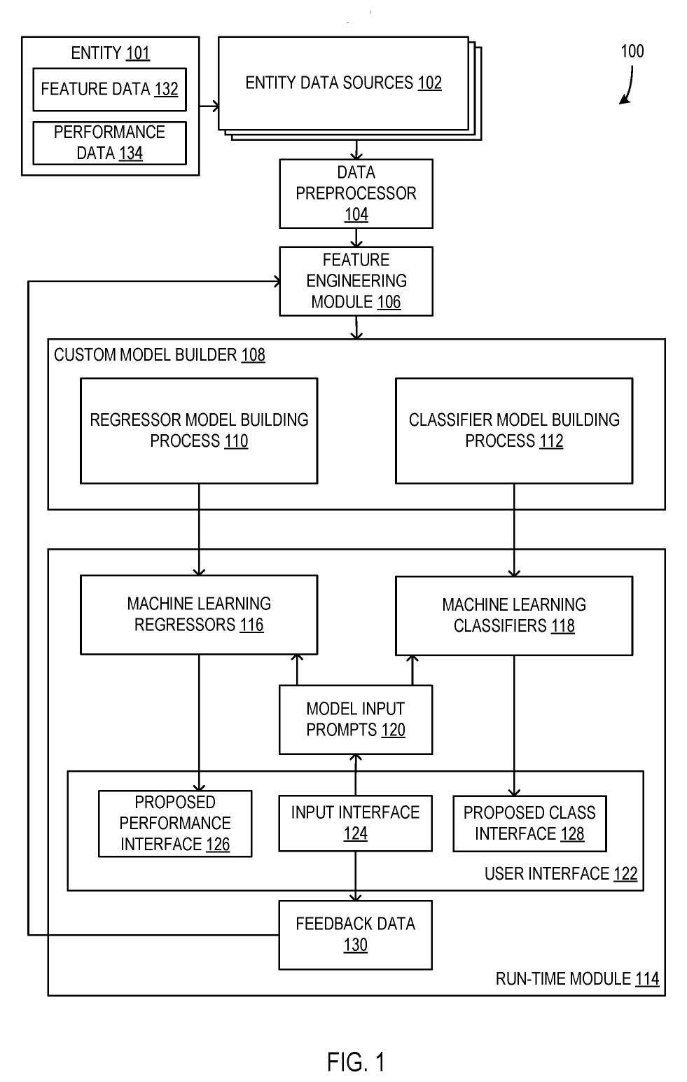

Corresponding reference characters indicate corresponding parts throughout the drawings. In FIGS. 1 to 6, the systems are illustrated as schematic drawings. The drawings may not be to scale. Any of the figures may be combined into a single example or embodiment.

### DETAILED DESCRIPTION

Aspects of the disclosure analyze performance data of entities in the context of entity classes and presentation of proposed outcomes of changes made to those entities. The disclosure includes training of regressor models and classifier models, such that proposed performance data can be generated in response to a proposed entity class change of an entity, and a proposed entity class can be generated in response to proposed performance data value changes of the entity. The disclosure includes a graphical user interface (GUI) or other user interface (UI) that is displayed and enables users to query the system regarding specific entities and changes to those entities and, in response, to view the proposed outcomes of the changes as determined by the trained models. For instance, in response to a proposed entity class change to an entity, the disclosed GUI is updated to include one or more proposed performance data value changes and/or comparative visualization of the proposed performance data value changes with the performance data values of other similar entities. Alternatively, or additionally, in another example, in response to a proposed performance data value change to an entity, the disclosed GUI is updated to include a proposed entity class for the entity and/or a similar comparative visualization of the entity with other similar entities in the proposed entity class.

The disclosure operates in an unconventional manner at least by using trained models to analyze changes to entities in two directions: from proposed entity class change to proposed performance data value changes and from proposed performance data value changes to proposed entity class change. The disclosure provides technical flexibility and technically efficient analysis of entity data which substantially reduces the time and effort required to perform such analysis and reduces the use of system resources, such as processing resources, memory resources, and/or network resources, when compared to other systems.

Further, the disclosure includes a user-friendly GUI for presenting the analysis results and highlighting proposed changes to entities, such that the disclosure describes the integration of a process into a practical application. The disclosure describes automatically displaying icons to the user and moving such icons based on the performed model analysis which provides a user experience improvement over prior systems and results in reduced resource costs compared to systems that lack a comprehensive GUI for the described data analysis.

In some examples, the entities are customers in a sales planning system, but in other examples, the entities can be of different types without departing from the description. In a sales planning system embodiment, the disclosure includes a dynamic and scalable decision-support system to enhance the sales operations planning process, with a focus on effectively categorizing customer account entities based on strategic value and potential for growth. The disclosure enables the optimization of the sales strategy by efficiently classifying customer accounts into distinct segments or classes – Strategic and Major. Further, in some examples, the system has the capability to extend to other segments or classes such as Small and Medium-sized Businesses (SMB) and Small Medium & Corporate (SMC).

In some examples, the disclosure includes systems and methods that provide business and sales operations (BSO) ‘in-context Recommendations’ of seller assignments, quota, etc. The BSO is enabled to adjust the recommendations to see the predicted impact of changes on parameters, such as coverage ratio, continuity of coverage, industry purity, completeness, impact on quota, etc. Based on the predictive analysis, the BSO is enabled to finalize the most effective assignments.

Further, in some examples, the disclosure is directed toward the development of a robust and scalable customer account segmentation system based on sales strategies of corporations or other large, complex entities. This system is configured to classify customer accounts into distinct categories (e.g., Strategic, Major, Small and Medium-sized Businesses (SMB), and Small Medium & Corporate (SMC)). The segmentation process defines the customer account segment and sub-segment structure for a given year and/or the number of accounts per segment to best drive growth in the entity’s sales department. The disclosure enables the sales team to focus their efforts efficiently, tailor their approaches, and optimize revenue generation. An example of the disclosure is focused on two features of predictive modeling: predicting the impact of assigning an account to a segment and predicting a best segment for an account when given a set of performance data values. For instance, in an example, a sales planning manager wants to experiment with different segment options and gauge the impact of each option (e.g., what if we change Customer A from Major to Strategic? How will the change affect the predicted Account Coverage Ratio (ACR), Compound Annual Growth Rate (CAGR), and/or other performance indicators?). In another example, an area team is aware of upcoming business changes and needs to decide the new segments for the account (e.g., Customer B is expecting an increase in ACR by 4% next year, so the team wants to know whether to move Customer B from "Major" to "Strategic". Also, it would be interesting to see the expected values of Account Coverage Ratio (ACR), Compound Annual Growth Rate (CAGR), Billing Revenue (BR), Field Revenue Accountability (FRA), etc. as a result of the changed segment).

In some examples, the disclosure uses a methodology including the operations of data understanding and preparation; defining scope, objectives, and acceptance criteria; finalizing business requirements; identifying and getting access to relevant datasets; preprocessing and exploration of data to understand the quality and structure; gathering historical customer data, including revenue records, interaction history, customer demographics, and other relevant information; cleansing and preprocessing the data to handle missing values, outliers, and ensure data consistency; and combining datasets for analysis.

Further, in some examples, the disclosure includes the performance of exploratory data analysis (EDA). This analysis enables better understanding of data with respect to feature engineering for Machine Learning (ML)/Artificial Intelligence (AI) modeling. EDA is performed to gain insights into various datasets like the distribution of ACR/CAGR/BR over segments/subsegments/regions, correlation among different features, creating new variables and representations that can differentiate customer accounts based on the sales strategy.

Additionally, or alternatively, the disclosure describes ML modeling and evaluation. In some examples, K-Means and/or K-Medoids clustering is used to understand the distribution of various existing segments of customers or other entities. Multi-class classification models using Random Forest classifiers, XGBoost, Logistic Regression, Support Vector Machines (SVM), and/or Decision Trees are used to predict segment group and sub segment changes. Multiclass regressor and classifier models are used to predict target variables such as Account Coverage Ratio (ACR), Sensitivity Analysis for Account Ranking & Prioritization (SARP Rank), Head count and New Sub Segments. DICE (Diverse Counterfactual Explanations) and/or LIME (Local Interpretable Model-Agnostic Explanations) are used for feature interpretations and explainability.

Further, the disclosure describes the use of feedback loops and model iterations in some examples. The disclosure enables collaboration with stakeholders to design and collect user feedback for the feedback loop, understanding of the nuances of the sales strategy to align segmentation outputs, accordingly, conducting of usability testing and iterating based on business insights, and embedding of the feedback into the model retraining to monitor and optimize the model performance.

The disclosure describes the development of a predictive tool, or “what-if” tool, for analyzing performance and class of entities. The predictive tool is a web-enabled user-friendly interface which allows users to perform the following actions. If a user wants to move a particular account to a new subsegment, they will select that from a list of values. The expected values of key attributes like ACR, SARP rank, etc. for that account are displayed on the screen so that the user is enabled to understand the changes to be made. The user is enabled to provide % change in values of features like ACR, CAGR, etc. for the next Fiscal Year (FY) and the model returns a predicted new subsegment or class.

FIG. 1 is a block diagram illustrating an example system 100 for generating proposals about aspects of analyzed entities using trained machine learning (ML) models. In some examples, the system 100 obtains entity data (e.g., feature data 132 and/or performance data 134 of an entity 101) from entity data sources 102 and processes the obtained data with a data preprocessor 104 and a feature engineering module 106. A custom model builder 108 performs a regressor model building process 110 and/or a classifier model building process 112 using the processed data in order to train ML regressors 116 and/or ML classifiers 118. In a run-time module 114, model input prompts 120 are received from an input interface 124 of a user interface 122. The model input prompts 120 are used as input for the ML regressors 116 and/or the ML classifiers 118 and the output generated by the ML regressors 116 and/or ML classifiers 118 is displayed or otherwise presented with the user interface 122. Output of the ML regressors 116 is presented using a predicted or proposed performance interface 126 and output of the ML classifiers 118 is presented using a predicted or proposed class interface 128. In some such examples, feedback data 130 is received via the input interface 124 and used to inform the feature engineering module 106 in order to refine the training of the ML regressors 116 and/or ML classifiers 118 and improve the performance of those models over time.

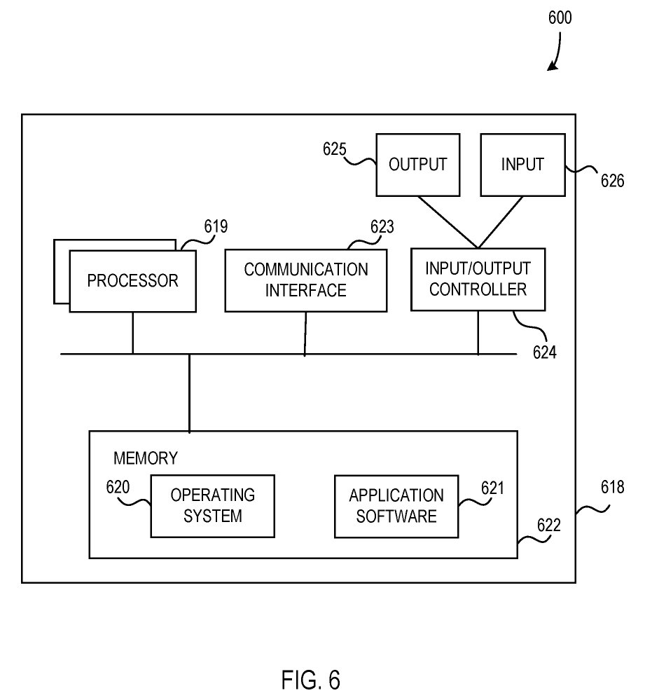

Further, in some examples, the system 100 includes one or more computing devices (e.g., the computing apparatus of FIG. 6) that are configured to communicate with each other via one or more communication networks (e.g., an intranet, the Internet, a cellular network, other wireless network, other wired network, or the like). In some examples, entities of the system 100 are configured to be distributed between the multiple computing devices and to communicate with each other via network connections. For example, the custom model builder 108 is executed on a first computing device and the run time module 114 is located on a second computing device within the system 100. The first computing device and second computing device are configured to communicate with each other via network connections. Alternatively, in some examples, other components of the run-time module 114 (e.g., the user interface 122, the ML regressors 116, and/or the ML classifiers 118) are executed on separate computing devices and those separate computing devices are configured to communicate with each other via network connections during the operation of the run-time module 114. In other examples, other organizations of computing devices are used to implement system 100 without departing from the description.

The entity data sources 102 receive and store data from entities 101 for use by the system 100. In some examples, the entities 101 provide data to the entity data sources 102 periodically and/or based on the occurrence of an event. Alternatively, or additionally, in some examples, the entity data sources 102 are configured to request or otherwise obtain the entity data from the entities 101. In some examples, an entity data source 102 is configured to store a defined type of data (e.g., a data source that specifically stores a subset of the types of entity performance data associated with a type of entity operation). Alternatively, or additionally, an entity data source 102 is configured to store entity data associated with a subset of the entities 101 (e.g., a data source that specifically stores entity data associated with entities that are located in a specific location or region). Further, in some examples, the entities 101 are customers of a company and the entity data sources 102 includes an account data source, a sales transaction data source, a sales segment data source, a salespeople data source, or the like.

In some examples, data preprocessor 104 receives or otherwise obtains entity data from the entity data sources 102 and performs preprocessing operations on the obtained entity data. For instance, in an example, the data preprocessor 104 explores the entity data to determine the qualities, patterns, and/or other structure of the data. Further, in some examples, the data preprocessor 104 performs preprocessing to handle missing values, outliers, and ensure data consistency. Additionally, or alternatively, in some examples, the data preprocessing performed by the data preprocessor 104 includes normalization and/or standardization of data values, encoding categorical variables, dimensionality reduction through methods like Principal Component Analysis (PCA), and/or other techniques like random sampling, stratified sampling, or the like.

The feature engineering module 106 includes hardware, firmware, and/or software configured to analyze the entity data and determine data features therein that can be used in the training of the ML regressors 116 and/or the ML classifiers 118. In some examples, the feature engineering module 106 is configured to select, manipulate, and/or transform raw entity data into the data features that will be used. For instance, raw transaction data is used to create a data feature that indicates an average monthly revenue over the past six months. Additionally, or alternatively, in some examples, the feature engineering module 106 implements more complex transformations, such as calculating the volatility of revenue and/or frequency of transactions within specific time windows.

The custom model builder 108 includes hardware, firmware, and/or software configured to create and train the ML learning regressors 116 and/or the ML learning classifiers 118 using a regressor model building process 110 and a classifier model building process 112, respectively. In some examples, the custom model builder 108 is configured to train an ML regressor 116 that receives input in the form of data describing an entity and an entity class to which the entity is or will be assigned, and the ML regressor 116 generates output that includes predicted or proposed performance data values of that entity with respect to the input entity class. Additionally, or alternatively, in some examples, the custom model builder 108 is configured to train an ML classifier 118 that receives input in the form of data describing an entity and performance data values of the entity, and the ML classifier 118 generates output that includes a predicted or recommended entity class for the input entity.

In some examples, the regressor model building process 110 and/or the classifier model building process 112 include ML and/or AI training techniques and make use of real entity data from entity data sources 102 and/or synthetic entity data that has been generated to reflect patterns in real entity data. Further, in some examples, the model building processes 110-112 include the performance of multiple iterations of training operations, whereby the accuracy and/or efficiency of the models being trained is improved over time in each iteration. For instance, in an example, an ML regressor 116 that is being trained via the regressor model building process 110 is provided a set of data features associated with an entity 101, including an indicator of the entity class of the entity 101. The ML regressor 116 performs operations using the input data features to generate one or more proposed performance data values. The regressor model building process 110 then compares the output proposed performance data values to real performance data values of the entity 101 and, based on the difference between the model output and the real data values, parameters and/or other aspects of the ML regressor 116 are adjusted to improve its efficiency. This process is performed many times using data from many different entities, such that the efficiency of the ML regressor 116 is improved incrementally over time. Additionally, or alternatively, in some examples, the same operations are performed with respect to an ML classifier 118 being trained in the classifier model building process 112, except that the input data features of the entity 101 include performance data values, and the output generated by the ML classifier 118 is a predicted or recommended entity class, which is then compared to the real entity class of the entity 101.

It should be understood that, in other examples, different ML model training techniques are used in the regressor model building process 110 and/or the classifier model building process 112 without departing from the description.

During run-time operation of the system 100, the run-time module 114 includes hardware, firmware, and/or software configured to receive model input prompts 120 from an input interface 124, provide those model input prompts 120 to ML regressors 116 and/or ML classifiers 118, and to present the output of the ML regressors 116 and/or ML classifiers 118 via a proposed performance interface 126 and/or a proposed class interface 128, respectively. In some examples, the input interface 124 includes prompts for a user to direct the user regarding the type of information to include in a model input prompt 120. For instance, in an example, the input interface 124 is configured to prompt a user to provide either performance data values of an entity (e.g., the ACR, CAGR, BR, and/or FRA associated with a sales customer entity) or to provide a potential entity class of the entity (e.g., Strategic, Major, Small and Medium-sized Businesses (SMB), and Small Medium & Corporate (SMC) classes of sales customer entities).

In response to receiving the model input prompts 120, the run-time module 114 is configured to provide those model input prompts 120 to the ML regressors 116 and/or the ML classifiers 118. The output data of the ML regressors 116 is provided for presentation on the proposed performance interface 126 and the output data of the ML classifiers 118 is provided for presentation on the proposed class interface 128. In some examples, the run-time module 114 is configured to perform interactive predictive analytics. For instance, in some such examples, the run-time module 114 incorporates user feedback data 130 directly into the feature input process of the models 116 and/or 118, thereby fine-tuning model parameters during real time and/or calibrating the model’s outputs based on user corrections and preferences. Further, in some examples, the run-time module 114 is configured to create multiple “what-if” scenarios quickly. The run-time module 114 computes and compares the scenarios in real-time, allowing users to interactively explore and visualize different outcomes based on varied inputs.

Additionally, or alternatively, in some examples, the run-time module 114 is configured to execute both regressor models 116 and classifier models 118 in parallel, optimizing computational resources and reducing response time. This setup allows simultaneous predictions or proposals of different metrics or categories. Further, in some examples, the run-time module 114 is configured to use model caching techniques to speed up predictions or proposals. Once loaded in memory, the models 116 and 118 are kept in memory for faster execution, avoiding the overhead of reloading models for each query.

In some examples, the proposed performance interface 126 is configured to present proposed performance data values of an entity to a user via a GUI. Additionally, in some examples, the proposed performance interface 126 displays other information about the entity as well, such as identifying information, the current entity class of the entity, past performance data values of the entity, and/or performance data values of other entities that are in the same entity class for comparison purposes.

Further, in some examples, the proposed class interface 128 is configured to present a proposed or recommended class (or multiple classes) of an entity to a user via a GUI. Additionally, in some examples, the proposed class interface 128 displays other information about the entity as well, such as identifying information, past performance data values of the entity, and/or performance data values of other entities that are in the same entity class for comparison purposes.

Additionally, or alternatively, in some examples, in response to output presented via the proposed performance interface 126 and/or the proposed class interface 128, the input interface 124 receives feedback data 130 (e.g., an indication from a user that the output information presented by the user interface 122 is incorrect or inaccurate). The feedback data 130, along with the model input prompts 120 and output data from the ML learning regressors 116 and/or ML learning classifiers 118 are provided as feedback to the feature engineering module 106. In some such examples, the feedback data 130 is used by the feature engineering module 106 and/or the custom model builder 108 to fine-tune the ML regressors 116 and/or ML classifiers 118 based on the feedback data 130. In this way, the system 100 enables the ML regressors 116 and ML classifiers 118 to continuously improve through interactions with users via the run-time module 114.

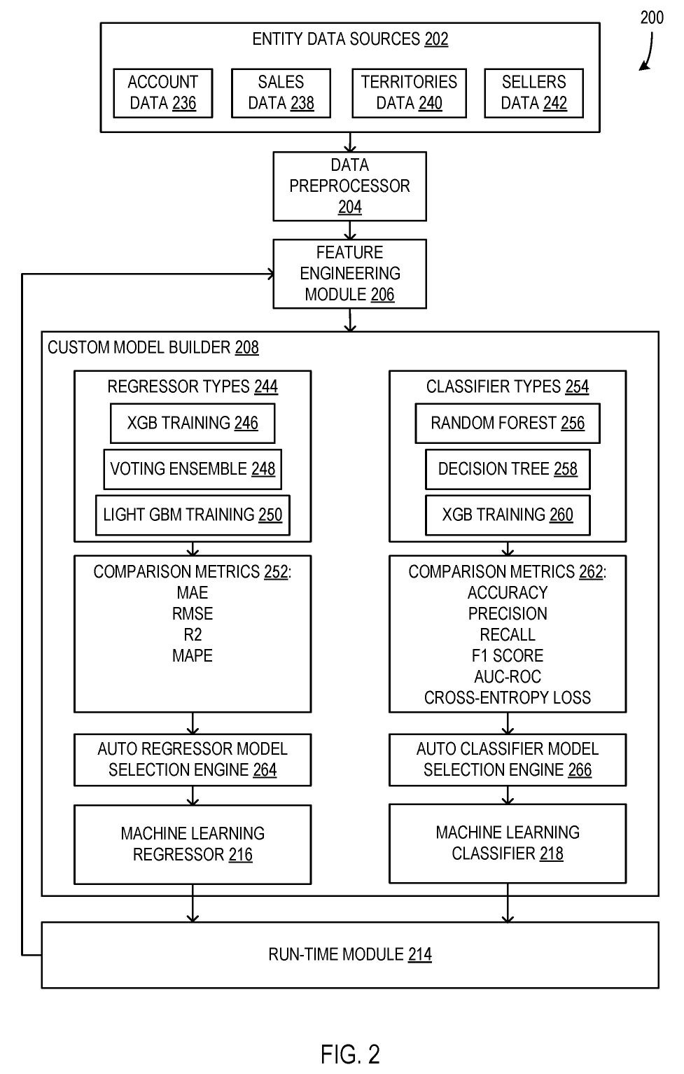

FIG. 2 is a block diagram illustrating an example system 200 for training ML models for analyzing customer entity data. In some examples, the system 200 is part of or associated with a system such as system 100 of FIG. 1.

Further, the system 200 includes entity data sources 202 including account data 236, sales data 238, territories data 240, and sellers data 242. In other examples, more, fewer, and/or different types of entity data sources 202 are in the system 200 without departing from the description. As described above with respect to data preprocessor 104 in FIG. 1, a data preprocessor 204 performs preprocessing operations on the data from the entity data sources 202 and provides the preprocessed data to the feature engineering module 206. The feature engineering module 206 is configured to analyze the entity data and determine data features therein that can be used in the training of the ML regressors 216 and/or the ML classifiers 218, as described above with respect to feature engineering module 106 of FIG. 1.

The custom model builder 208 is configured to use the features generated by the feature engineering module 206 to train and build a wide variety of models. For instance, in some examples, the custom model builder 208 builds and trains regressor types 244 such as XGBoost (XGB) regressor training 246, voting ensemble training 248, and/or Light Gradient-Boosting Machine (light GBM) regressor training 250. Additionally, or alternatively, in some examples, the custom model builder 208 builds and trains classifier types 254 such as random forest training 256, decision tree training 258, and/or XGB classifier training 260.

After multiple regressor models from various regressor types 244 are trained, the performances of the regressor models are compared using one or more comparison metrics 252, such as the Mean Absolute Error (MAE), the Root Mean Squared Error (RMSE), the R² value (the coefficient of determination), and/or the Mean Absolute Percentage Error (MAPE). These metrics evaluate the efficiency and consistency of regression models. Depending on specific requirements, additional or different comparison metrics are employed without deviating from the fundamental approach.

After multiple classifier models from various classifier types 254 are trained, the performances of the classifier models are compared using one or more comparison metrics 262 for classification, such as accuracy, precision, recall, F₁ score (the harmonic mean of the precision and recall), Area Under the Receiver Operating Characteristics Curve (AUC-ROC), and/or cross-entropy loss. These metrics are critical in evaluating the effectiveness of classifiers in correctly predicting target class labels. In other examples, the selection process also considers outer comparison metrics 262 as needed to ensure robust evaluation.

The custom model builder 208 includes an automatic regressor model selection engine 264 that is configured to select a regressor model to be the ML regressor 216 from the group of trained regressor models based on the comparison metrics 252. In some examples, the automatic regressor model selection engine 264 compares metric values of a single comparison metric 252 from each trained regressor model and selects the regressor model with the best performance based on that single comparison metric 252. Alternatively, in some examples, the automatic regressor model selection engine 264 uses a plurality of comparison metrics 252 to evaluate the trained regressor models, including applying weight factors to the metric values for each comparison metric 252 being used (e.g., weighting RMSE more heavily than MAE) to prioritize certain comparison metrics 252 over others based on their relevance to the specific application. In addition to weighting the comparison metrics 252 with different weight factors, in some examples, the automatic regressor model selection engine 264 performs other operations on the metric values, such as normalization of different types of metric values, to ensure a fair comparison across different types of metric values. The automatic regressor model selection engine 264 uses meta-learning techniques where the selection engine 264 learns from past model performance data to predict which type of model might perform best under similar circumstances. When the automatic regressor model selection engine 264 selects an ML regressor 216, that regressor is provided to the run-time module 214 for use therein, ensuring that the best-performing model is used for the generation of predictions and/or proposals.

The custom model builder 208 includes an automatic classifier model selection engine 266 that is configured to select a classifier model to be the ML classifier 218 from the group of trained classifier models based on the comparison metrics 262. In some examples, the automatic classifier model selection engine 266 compares metric values of a single comparison metric 262 from each trained classifier model and selects the classifier model with the best performance based on that single comparison metric 262. Alternatively, in some examples, the automatic classifier model selection engine 266 uses a plurality of comparison metrics 262 to evaluate the trained classifier models, including applying weight factors to the metric values for each comparison metric 262 being used. In addition to weighting the comparison metrics 262 with different weight factors, in some examples, the automatic classifier model selection engine 266 performs other operations on the metric values, such as normalization of different types of metric values. When the automatic classifier model selection engine 266 selects an ML classifier 218, that classifier is provided to the run-time module 214 for use therein.

In some examples, the run-time module 214 operates as described above with respect to run-time module 114 of FIG. 1. The run-time module 214 uses the ML regressor 216 and ML classifier 218 to analyze entity data and generate model output in response to prompts from users as described herein.

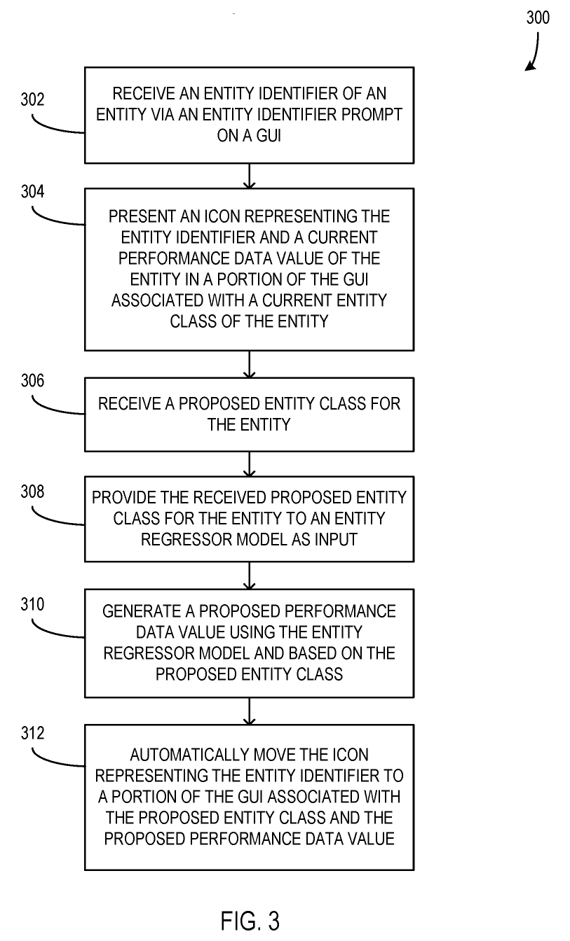

FIG. 3 is a flowchart illustrating an example method 300 for generating proposed performance data values of an entity based on a proposed entity class of the entity. In some examples, the method 300 is executed or otherwise performed in a system such as system 100 of FIG. 1.

At 302, an entity identifier of an entity is received via an entity identifier prompt on a GUI (e.g., GUI 500). In some examples, the entity identifier prompt requests that user provides an entity identifier and provides a location on the GUI in which the entity identifier can be entered (e.g., a text box). Alternatively, or additionally, the entity identifier prompt includes a list or other group of possible entity identifiers and enables a user to select one of the entity identifiers from the list or other group.

At 304, an icon representing the entity identifier of the entity and a current performance data value of the entity is presented in a portion of the GUI associated with a current entity class of the entity. In some examples, the icon is an image or symbol associated with the entity identified by the entity identifier or a portion of the entity identifier itself, such as the first letters of each word in the entity identifier. Further, in some examples, the portion of the GUI associated with the current entity class of the entity is added to the GUI based on a user’s selection of the entity identifier of the entity at 302. Alternatively, or additionally, in some examples, the GUI includes a plurality of portions that are each associated with a different entity class and, upon the entity identifier of the entity being received, the GUI portion associated with the entity class of the entity is highlighted or otherwise altered in appearance to draw the attention of the user. Further, in some examples, the GUI portion associated with the current entity class of the entity includes a list or other group of entities that are in the current entity class arranged in an order based on performance data values, wherein the entity is listed in the list or other group of entities in a location based a comparison of the current performance data value of the entity to the performance data values of other entities listed in the list or other group of entities.

At 306, a proposed entity class for the entity is received. In some examples, the GUI includes a proposed entity class prompt that is configured to enable a user to select a proposed entity class for the entity that is different than its current entity class and, as a result of the selection, to view proposed changes to the performance data value(s) of the entity as described herein. In some such examples, the user is enabled to select a proposed entity class from a list of possible entity classes.

At 308, the received proposed entity class for the entity is provided to an entity regressor model (e.g., ML regressors 116 and/or ML regressor 216) as input. In some examples, the entity regressor model is also provided other information about the entity, such as current performance data values of the entity in its current entity class.

At 310, a proposed performance data value is generated using the entity regressor model and based on the proposed entity class. In some examples, the entity regressor model generates a plurality of proposed performance data values. Further, in some such examples, those proposed performance data values are compared to the same performance data values of the entity in its current entity class and the differences between the performance data values, or performance data value changes, are highlighted on the GUI (e.g., the difference between the ACR of the entity in its current entity class and the proposed ACR of the entity if it is changed to the proposed entity class).

At 312, the icon representing the entity identifier is automatically moved to a portion of the GUI associated with the proposed entity class and the proposed performance data value. In some examples, the GUI portion associated with the proposed entity class includes a list or other group of entities that are in the proposed entity class arranged in an order based on performance data values thereof. Thus, the icon representing the entity identifier of the entity is moved to the list or other group of entities in the proposed entity class and placed in a position on the list based on the comparison of the proposed performance data value of the entity to the performance data values of the other entities on the list or other group of entities in the proposed entity class.

Additionally, or alternatively, in some examples, an entity class action of the proposed entity class is automatically performed in association with the entity. For instance, in an example where the entity is a customer to which sales of goods or services are made and the proposed entity class of the entity includes specific types of sales communication actions with the customer, a user of the GUI is prompted to indicate whether they want the customer to be placed in the proposed entity class and, if the user confirms the placement, a sales communication associated with the proposed entity class is automatically initiated with that customer.

Further, in some examples, the entity class action includes determining one or more entity interactions associated with the proposed entity class and generating a schedule data structure for the determined one or more entity interactions. The schedule data structure is generated to include a performance datetime associated with each of the one or more entity actions. Based on the generated schedule data structure, the entity interactions are automatically performed at the datetimes with which they are associated.

In some examples, the method 300 further includes training a plurality of prospective regressor models and selecting the entity regressor model to be used from the plurality of prospective regressor models. For instance, in an example, a first prospective regressor model of a first regressor model type (e.g., trained using XGB training) is trained using a training data set that includes performance data and entity class data. A second prospective regressor model of a second regressor model type (e.g., a voting ensemble model) is trained using the training data set as well. A first test output is generated with the first prospective regressor model and a second test output is generated with the second prospective regressor model. The first and second test outputs are compared to determine the efficiency of the first and second prospective regressor models and the more efficient model is selected for use as the entity regressor model (e.g., if the first prospective regressor model is shown to be more accurate than the second prospective regressor model, the first prospective regressor model is selected for use as the entity regressor model).

Further, in some examples, user feedback is collected by the GUI in response to the generated proposed performance data value(s) and that user feedback is used in the next iteration of training of the entity regressor model (e.g., the user feedback is used to fine tune the entity regressor model to improve its efficiency or other performance metric over time). For instance, in FIG. 1, the feedback data 130 is fed back into the feature engineering module 106 and used to iteratively train the ML regressors 116.

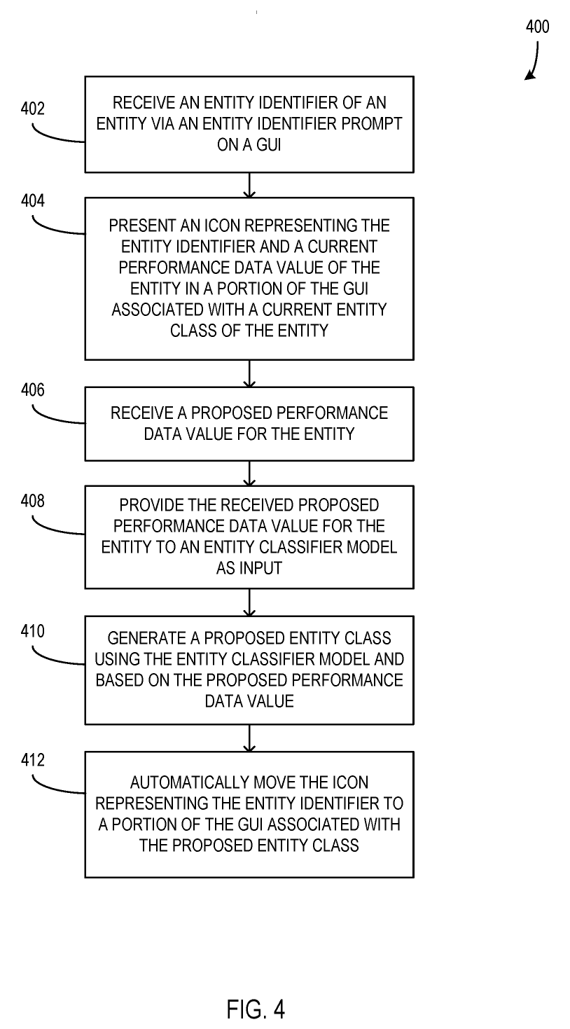

FIG. 4 is a flowchart illustrating an example method 400 for generating a proposed entity class of an entity based on a proposed performance data value of the entity. In some examples, the method 400 is executed or otherwise performed in a system such as system 100 of FIG. 1.

At 402, an entity identifier of an entity is received via an entity identifier prompt on a GUI (e.g., GUI 500). In some examples, the entity identifier prompt requests that user provides an entity identifier and provides a location on the GUI in which the entity identifier can be entered (e.g., a text box). Alternatively, or additionally, the entity identifier prompt includes a list or other group of possible entity identifiers and enables a user to select one of the entity identifiers from the list or other group.

At 404, an icon representing the entity identifier of the entity and a current performance data value of the entity is presented in a portion of the GUI associated with a current entity class of the entity. In some examples, the icon is an image or symbol associated with the entity identified by the entity identifier or a portion of the entity identifier itself, such as the first letters of each word in the entity identifier. Further, in some examples, the portion of the GUI associated with the current entity class of the entity is added to the GUI based on a user’s selection of the entity identifier of the entity at 402. Alternatively, or additionally, in some examples, the GUI includes a plurality of portions that are each associated with a different entity class and, upon the entity identifier of the entity being received, the GUI portion associated with the entity class of the entity is highlighted or otherwise altered in appearance to draw the attention of the user. Further, in some examples, the GUI portion associated with the current entity class of the entity includes a list or other group of entities that are in the current entity class arranged in an order based on performance data values, wherein the entity is listed in the list or other group of entities in a location based a comparison of the current performance data value of the entity to the performance data values of other entities listed in the list or other group of entities.

At 406, a proposed performance data value for the entity is received. In some examples, the GUI includes a proposed performance data value prompt that is configured to enable a user to select a proposed performance data value type for the entity and to provide a data value for that selected performance data value type. As a result of the selection, a proposed change to the entity class of the entity is presented as described herein. In some such examples, the user is enabled to select a proposed performance data value type from a list of possible performance data value types. Further, in some examples, the user of the GUI is enabled to provide a plurality of proposed performance data values associated with a plurality of different performance data value types without departing from the description.

At 408, the received proposed performance data value for the entity is provided to an entity classifier model (e.g., ML classifiers 118 and/or ML classifier 218) as input. In some examples, the entity classifier model is also provided other information about the entity, such as other current performance data values of the entity in its current entity class.

At 410, a proposed entity class is generated using the entity classifier model and based on the proposed performance data value. In some examples, the entity classifier model generates a plurality of proposed entity classes with different confidence levels (e.g., values indicating a likelihood that an associated proposed entity class is a best fit for the entity). Further, in some such examples, those proposed performance data values are compared to the same performance data values of other entities of the proposed entity class and the differences between the performance data values, or performance data value changes, are highlighted on the GUI (e.g., the degree to which the proposed ACR of the entity differs from the ACRs of other entities in the proposed entity class).

At 412, the icon representing the entity identifier is automatically moved to a portion of the GUI associated with the proposed entity class and the proposed performance data value. In some examples, the GUI portion associated with the proposed entity class includes a list or other group of entities that are in the proposed entity class arranged in an order based on performance data values thereof. Thus, the icon representing the entity identifier of the entity is moved to the list or other group of entities in the proposed entity class and placed in a position on the list based on the comparison of the proposed performance data value of the entity to the performance data values of the other entities on the list or other group of entities in the proposed entity class.

Additionally, or alternatively, in some examples, an entity class action of the proposed entity class is automatically performed in association with the entity. For instance, in an example where the entity is a customer to which sales of goods or services are made and the proposed entity class of the entity includes specific types of sales communication actions with the customer, a user of the GUI is prompted to indicate whether they want the customer to be placed in the proposed entity class and, if the user confirms the placement, a sales communication associated with the proposed entity class is automatically initiated with that customer.

Further, in some examples, the entity class action includes determining one or more entity interactions associated with the proposed entity class and generating a schedule data structure for the determined one or more entity interactions. The schedule data structure is generated to include a performance datetime associated with each of the one or more entity actions. Based on the generated schedule data structure, the entity interactions are automatically performed at the datetimes with which they are associated.

In some examples, the method 400 further includes training a plurality of prospective classifier models and selecting the entity classifier model to be used from the plurality of prospective classifier models. For instance, in an example, a first prospective classifier model of a first classifier model type (e.g., a random forest model) is trained using a training data set that includes performance data and entity class data. A second prospective classifier model of a second classifier model type (e.g., a decision tree model) is trained using the training data set as well. A first test output is generated with the first prospective classifier model and a second test output is generated with the second prospective classifier model. The first and second test outputs are compared to determine the accuracy of the first and second prospective classifier models and the more accurate model is selected for use as the entity classifier model (e.g., if the first prospective classifier model is shown to be more accurate than the second prospective classifier model, the first prospective classifier model is selected for use as the entity classifier model).

Further, in some examples, user feedback is collected by the GUI in response to the generated proposed performance data value(s) and that user feedback is used in the next iteration of training of the entity classifier model (e.g., the user feedback is used to fine tune the entity classifier model to improve its accuracy or other performance metrics over time). For instance, in FIG. 1, the feedback data 130 is fed back into the feature engineering module 106 and used to iteratively train the ML classifiers 118.

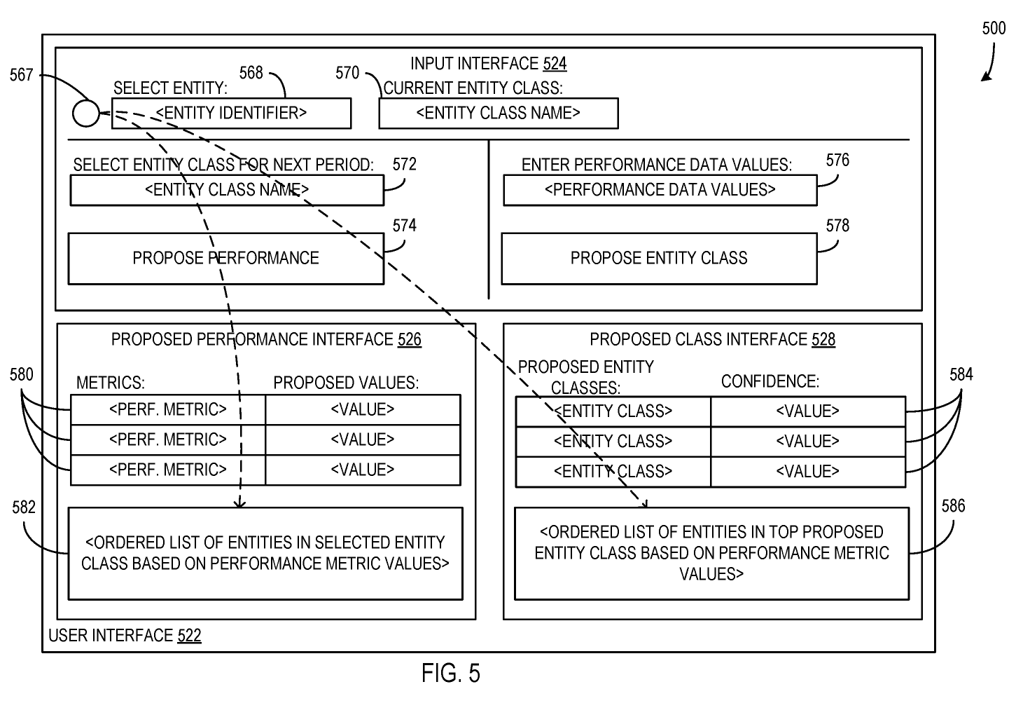

FIG. 5 is a diagram illustrating an example GUI 500 for displaying proposed aspects of entities. In some examples, the GUI 500 is displayed in a system such as system 100 of FIG. 1. Further, in some examples, the GUI 500 is displayed as part of a method such as methods 300 and 400 of FIGS. 3 and 4, respectively.

The GUI 500 includes a user interface 522 comprising an input interface 524, a proposed performance interface 526, and a proposed class interface 528. The input interface 524 includes a prompt 568 that prompts a user for an entity identifier and an associated element 570 that displays the current entity class of the entity that is identified by an entity identifier that the user provides. Further, an icon 567 that represents the provided entity identifier in prompt 568 is displayed as well. In some examples, the icon 567 includes a portion of the entity identifier (e.g., the first letters of each word of the entity identifier) and/or an image or symbol that is representative of the entity identified by the entity identifier (e.g., a logo associated with a business entity).

Further, the input interface 524 includes a prompt 572 that enables a user to select an entity class for the entity during the next time period (e.g., during the next fiscal year). Along with the prompt 572 is a button 574 that can be activated to generate proposed performance data values of the selected entity if the entity is placed in the selected entity class in prompt 572. After selecting an entity class in prompt 572, the user is enabled to activate the button 574 to generate data for and populate the proposed performance interface 526.

Additionally, the input interface 524 includes a prompt 576 that enables a user to enter proposed performance data values for the selected entity (e.g., predicted performance data values for the next fiscal year). Along with the prompt 576 is a button 578 that can be activated to generate a proposed entity class for the entity based on the provided performance data values in the prompt 576. After providing the performance data values in the prompt 576, the user is enabled to activate the button 578 to generate data for and populate the proposed class interface 528.

The proposed performance interface 526 includes a group 580 of performance metrics and proposed performance data values associated with those metrics. The proposed performance data values are generated by a model as described herein based on the proposed entity class change for the selected entity via the prompt 572. In addition, the group 580 of performance metrics, a section 582 is displayed that includes an ordered list of entities in the selected entity class that are arranged based on performance metric values. The icon 567 of the selected entity is automatically moved to a position in the ordered list based on its proposed performance data values displayed in the group 580, such that it is displayed after other entities that perform better than the entity’s proposed performance data values and it is displayed before other entities that perform worse than the entity’s proposed performance data values. In some examples, other information is also displayed in addition to the icon 567, such as the entity identifier itself and/or the performance data value(s) that is/are being used to arrange the list section 582.

The proposed class interface 528 includes a group 584 of proposed entity classes for the selected entity and confidence values (e.g., values indicating the likelihood the entity class is a best fit for the selected entity). The proposed entity classes are generated by a model as described herein based on the proposed performance data value(s) for the selected entity via the prompt 576. In addition, the group 584 of proposed entity classes, a section 586 is displayed that includes an ordered list of entities in the top proposed entity class that are arranged based on performance metric values. The icon 567 of the selected entity is automatically moved to a position in the ordered list based on its proposed performance data values as provided in prompt 576, such that it is displayed after other entities that perform better than the entity’s proposed performance data values and it is displayed before other entities that perform worse than the entity’s proposed performance data values. In some examples, other information is also displayed in addition to the icon 567, such as the entity identifier itself and/or the performance data value(s) that is/are being used to arrange the list section 586.

### Additional Examples:

In an example, the disclosure enables proactive segmentation for business changes. The disclosure equips an area time with predictive modeling capabilities to anticipate the impact of unannounced business changes, such as a projected increase in revenue for specific customer accounts. Further, it determines the suitability of transitioning accounts to more appropriate segments based on predicted growth and other critical financial indicators. Teams are enabled to visualize and assess the expected values of key financial metrics post-reclassification to decide on the most beneficial segment alignment for future growth. Thus, the disclosure enables such teams to use a more agile, informed, and data-driven sales strategy.

In some examples, the disclosed systems and methods provide an ML modeling tool that is trained on dataset that include features such as ACR, CAGR, Global Rank, Head Count, and others. The tool is directed to allowing users to modify values of specific features, such as adjusting ACR by a certain percentage or altering CAGR, and then observing the predicted changes in the class or segment. This aspect of the tool is particularly useful for strategic sales planning and scenario analysis, providing insights into how changes in certain metrics could potentially influence the classification outcome. Additionally, the tool offers the capability to select a new segment for an existing customer account or other entity and then predicts what the expected values of other variables, like ACR or CAGR, would be for this new segment. This reverse analysis feature aids in understanding what characteristic changes are typical or necessary for moving an entity to a different segment. In summary, this what-if tool enables users to simulate and predict the impact of various changes in key metrics on classification outcomes. Its adaptability in handling forward and reverse analysis not only makes it valuable for field sales decision-makers but also enhances understanding of the underlying features and their relationships as part of sales planning.

Further, in some examples, the described analysis of an entity is expanded to be performed automatically on multiple entities in multiple entity classes. For example, the described system is configured to periodically analyze the current performance data values of all entities and generate proposed entity classes for those analyzed entities. If a proposed entity class differs from the current entity class of an entity and has a sufficiently high confidence value (e.g., a confidence value above a defined threshold), the system automatically takes an action, such as generating a notification to notify a user that the entity might fit better in the proposed entity class.

Additionally, or alternatively, in some examples, the described system is configured to analyze all the entities periodically or based on the occurrence of an event and, as a result of that analysis, to generate a proposed entity class plan that divides all entities into their proposed entity classes based on the current performance data available. The proposed entity class plan includes performance data of all the entities and comprehensive structure of the entity classes based on current performance data, enabling users to view an overall plan and make decisions based thereon.

### Exemplary Operating Environment

The present disclosure is operable with a computing apparatus according to an embodiment as a functional block diagram 600 in FIG. 6. In an example, components of a computing apparatus 618 are implemented as a part of an electronic device according to one or more embodiments described in this specification. The computing apparatus 618 comprises one or more processors 619 which may be microprocessors, controllers, or any other suitable type of processors for processing computer executable instructions to control the operation of the electronic device. Alternatively, or in addition, the processor 619 is any technology capable of executing logic or instructions, such as a hard-coded machine. In some examples, platform software comprising an operating system 620 or any other suitable platform software is provided on the apparatus 618 to enable application software 621 to be executed on the device. In some examples, analyzing entity data to generate proposed entity classes and/or performance data values as described herein is accomplished by software, hardware, and/or firmware.

In some examples, computer executable instructions are provided using any computer-readable media that is accessible by the computing apparatus 618. Computer-readable media include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 622) is shown within the computing apparatus 618, it will be appreciated by a person skilled in the art, that, in some examples, the storage is distributed or located remotely and accessed via a network or other communication link (e.g., using a communication interface 623).

Further, in some examples, the computing apparatus 618 comprises an input/output controller 624 configured to output information to one or more output devices 625, for example a display or a speaker, which are separate from or integral to the electronic device. Additionally, or alternatively, the input/output controller 624 is configured to receive and process an input from one or more input devices 626, for example, a keyboard, a microphone, or a touchpad. In one example, the output device 625 also acts as the input device. An example of such a device is a touch sensitive display. The input/output controller 624 may also output data to devices other than the output device, e.g., a locally connected printing device. In some examples, a user provides input to the input device(s) 626 and/or receives output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: receive an entity identifier of an entity via an entity identifier prompt on a GUI; present an icon representing the entity identifier and a current performance data value of the entity in a portion of the GUI associated with a current entity class of the entity; receive a proposed entity class for the entity; provide the received proposed entity class for the entity to an entity regressor model as input; generate a proposed performance data value using the entity regressor model and based on the proposed entity class; and automatically move the icon representing the entity identifier to a portion of the GUI associated with the proposed entity class and the proposed performance data value.

An example computerized method comprises receiving an entity identifier of an entity via an entity identifier prompt on a GUI; presenting an icon representing the entity identifier and a current performance data value of the entity in a portion of the GUI associated with a current entity class of the entity; receiving a proposed performance data value for the entity; providing the received proposed performance data value for the entity to an entity classifier model as input; generating a proposed entity class using the entity classifier model and based on the proposed performance data value; and automatically moving the icon representing the entity identifier to a portion of the GUI associated with the proposed entity class.

One or more computer storage media having computer-executable instructions that, upon execution by a processor, case the processor to at least receive an entity identifier of an entity via an entity identifier prompt on a GUI; present an icon representing the entity identifier and a current performance data value of the entity in a portion of the GUI associated with a current entity class of the entity; receive a proposed performance data value for the entity; provide the received proposed performance data value for the entity to an entity classifier model as input; generate a proposed entity class using the entity classifier model and based on the proposed performance data value; and automatically move the icon representing the entity identifier to a portion of the GUI associated with the proposed entity class.

Alternatively, or in addition to the other examples described herein, examples include any combination of the following: -further comprising automatically performing an entity class action of the proposed entity class in association with the entity. -wherein the entity class action of the proposed entity class includes: determining one or more entity interactions associated with the proposed entity class; generating a schedule data structure for the determined one or more entity interactions, wherein the schedule data structure includes a performance datetime associated with each of the one or more entity interactions; and automatically performing an entity interaction of the one or more entity interactions at the performance datetime with which the entity interaction is associated in the generated schedule data structure. -wherein the portion of the GUI associated with the proposed entity class includes an ordered list of icons representing entity identifiers, wherein the ordered list of icons is ordered based on performance data values of entities with which the icons representing entity identifiers are associated; and wherein automatically moving the icon representing the entity identifier to the portion of the GUI associated with the proposed entity class includes inserting the icon representing the entity identifier into the list of icons representing entity identifiers based on comparisons of the proposed performance data value to the performance data values of entities with which the icons representing entity identifiers are associated. -further comprising training the entity classifier model, the training comprising: training a first prospective model of a first classifier model type using a training data set including performance data and entity class data; training a second prospective model of a second classifier model type using the training data set; generating a first test output of the first prospective model; generating a second test output of the second prospective model; and selecting the first prospective model as the entity classifier model based on a comparison of the first test output and the second test output indicating that the first prospective model is more accurate than the second prospective model. -further comprising: receiving user feedback in response to automatically moving the icon representing the entity identifier to a portion of the GUI associated with the proposed entity class; and training the entity classifier model using the received user feedback. -further comprising: determining a plurality of performance data value changes associated with performance data values of the entity based changing the entity to the proposed entity class using an entity regressor model; and displaying the determined plurality of performance data value changes on a portion of the GUI near the icon representing the entity identifier.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for receiving an entity identifier of an entity via an entity identifier prompt on a graphical user interface (GUI); exemplary means for presenting an icon representing the entity identifier and a current performance data value of the entity in a portion of the GUI associated with a current entity class of the entity; exemplary means for receiving a proposed performance data value for the entity; exemplary means for providing the received proposed performance data value for the entity to an entity classifier model as input; exemplary means for generating a proposed entity class using the entity classifier model and based on the proposed performance data value; and exemplary means for automatically moving the icon representing the entity identifier to a portion of the GUI associated with the proposed entity class.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
receive an entity identifier of an entity via an entity identifier prompt on a user interface (UI);
present an icon representing the entity identifier and a current performance data value of the entity in a portion of the UI associated with a current entity class of the entity;
receive a proposed entity class for the entity;
provide the received proposed entity class for the entity to an entity regressor model as input;
generate a proposed performance data value using the entity regressor model and based on the proposed entity class; and
automatically move the icon representing the entity identifier to a portion of the UI associated with the proposed entity class and the proposed performance data value.

2. The system of claim 1, wherein the memory and the computer program code are configured to further cause the processor to automatically perform an entity class action of the proposed entity class in association with the entity.

3. The system of claim 2, wherein the entity class action of the proposed entity class includes:
determining one or more entity interactions associated with the proposed entity class;
generating a schedule data structure for the determined one or more entity interactions, wherein the schedule data structure includes a performance datetime associated with each of the one or more entity interactions; and
automatically performing an entity interaction of the one or more entity interactions at the performance datetime with which the entity interaction is associated in the generated schedule data structure.

4. The system of claim 1, wherein the portion of the UI associated with the proposed entity class and the proposed performance data value includes an ordered list of icons representing entity identifiers, wherein the ordered list of icons is ordered based on performance data values of entities with which the icons representing entity identifiers are associated; and
wherein automatically moving the icon representing the entity identifier to the portion of the UI associated with the proposed entity class and the proposed performance data value includes inserting the icon representing the entity identifier into the ordered list of icons representing entity identifiers based on comparisons of the proposed performance data value to the performance data values of entities with which the icons representing entity identifiers are associated.

5. The system of claim 1, wherein the memory and the computer program code are configured to further cause the processor to train the entity regressor model, the training comprising:
training a first prospective model of a first regressor model type using a training data set including performance data and entity class data;
training a second prospective model of a second regressor model type using the training data set;
generating a first test output of the first prospective model;
generating a second test output of the second prospective model; and
selecting the first prospective model as the entity regressor model based on a comparison of the first test output and the second test output indicating that the first prospective model is more accurate than the second prospective model.

6. The system of claim 1, wherein the memory and the computer program code are configured to further cause the processor to:
receive user feedback in response to automatically moving the icon representing the entity identifier to the portion of the UI associated with the proposed entity class; and
train the entity regressor model using the received user feedback.

7. The system of claim 1, wherein the memory and the computer program code are configured to further cause the processor to:
determine a plurality of performance data value changes associated with performance data values of the entity based on changing the entity to the proposed entity class using the entity regressor model; and
display the determined plurality of performance data value changes on a portion of the UI near the icon representing the entity identifier.

8. A computerized method comprising:
receiving an entity identifier of an entity via an entity identifier prompt on a graphical user interface (GUI);
presenting an icon representing the entity identifier and a current performance data value of the entity in a portion of the GUI associated with a current entity class of the entity;
receiving a proposed performance data value for the entity;
providing the received proposed performance data value for the entity to an entity classifier model as input;
generating a proposed entity class using the entity classifier model and based on the proposed performance data value; and
automatically moving the icon representing the entity identifier to a portion of the GUI associated with the proposed entity class.

9. The computerized method of claim 8, further comprising automatically performing an entity class action of the proposed entity class in association with the entity.

10. The computerized method of claim 9, wherein the entity class action of the proposed entity class includes:
determining one or more entity interactions associated with the proposed entity class;
generating a schedule data structure for the determined one or more entity interactions, wherein the schedule data structure includes a performance datetime associated with each of the one or more entity interactions; and
automatically performing an entity interaction of the one or more entity interactions at the performance datetime with which the entity interaction is associated in the generated schedule data structure.

11. The computerized method of claim 8, wherein the portion of the GUI associated with the proposed entity class includes an ordered list of icons representing entity identifiers, wherein the ordered list of icons is ordered based on performance data values of entities with which the icons representing entity identifiers are associated; and
wherein automatically moving the icon representing the entity identifier to the portion of the GUI associated with the proposed entity class includes inserting the icon representing the entity identifier into the ordered list of icons representing entity identifiers based on comparisons of the proposed performance data value to the performance data values of entities with which the icons representing entity identifiers are associated.

12. The computerized method of claim 8, further comprising training the entity classifier model, the training comprising:
training a first prospective model of a first classifier model type using a training data set including performance data and entity class data;
training a second prospective model of a second classifier model type using the training data set;
generating a first test output of the first prospective model;
generating a second test output of the second prospective model; and
selecting the first prospective model as the entity classifier model based on a comparison of the first test output and the second test output indicating that the first prospective model is more accurate than the second prospective model.

13. The computerized method of claim 8, further comprising:
receiving user feedback in response to automatically moving the icon representing the entity identifier to the portion of the GUI associated with the proposed entity class; and
training the entity classifier model using the received user feedback.

14. The computerized method of claim 8, further comprising:
determining a plurality of performance data value changes associated with performance data values of the entity based on changing the entity to the proposed entity class using an entity regressor model; and
displaying the determined plurality of performance data value changes on a portion of the GUI near the icon representing the entity identifier.

15. A computer storage medium has computer-executable instructions that, upon execution by a processor, cause the processor to at least:
receive an entity identifier of an entity via an entity identifier prompt on a graphical user interface (GUI);
present an icon representing the entity identifier and a current performance data value of the entity in a portion of the GUI associated with a current entity class of the entity;
receive a proposed performance data value for the entity;
provide the received proposed performance data value for the entity to an entity classifier model as input;
generate a proposed entity class using the entity classifier model and based on the proposed performance data value; and
automatically move the icon representing the entity identifier to a portion of the GUI associated with the proposed entity class.

16. The computer storage medium of claim 15, wherein the computer-executable instructions, upon execution by the processor, further cause the processor to at least automatically perform an entity class action of the proposed entity class in association with the entity.

17. The computer storage medium of claim 16, wherein the entity class action of the proposed entity class includes:
determining one or more entity interactions associated with the proposed entity class;
generating a schedule data structure for the determined one or more entity interactions, wherein the schedule data structure includes a performance datetime associated with each of the one or more entity interactions; and
automatically performing an entity interaction of the one or more entity interactions at the performance datetime with which the entity interaction is associated in the generated schedule data structure.

18. The computer storage medium of claim 15, wherein the portion of the GUI associated with the proposed entity class includes an ordered list of icons representing entity identifiers, wherein the ordered list of icons is ordered based on performance data values of entities with which the icons representing entity identifiers are associated; and
wherein automatically moving the icon representing the entity identifier to the portion of the GUI associated with the proposed entity class includes inserting the icon representing the entity identifier into the ordered list of icons representing entity identifiers based on comparisons of the proposed performance data value to the performance data values of entities with which the icons representing entity identifiers are associated.

19. The computer storage medium of claim 15, wherein the computer-executable instructions, upon execution by the processor, further cause the processor to at least train the entity classifier model, the training comprising:
training a first prospective model of a first classifier model type using a training data set including performance data and entity class data;
training a second prospective model of a second classifier model type using the training data set;
generating a first test output of the first prospective model;
generating a second test output of the second prospective model; and
selecting the first prospective model as the entity classifier model based on a comparison of the first test output and the second test output indicating that the first prospective model is more accurate than the second prospective model.

20. The computer storage medium of claim 15, wherein the computer-executable instructions, upon execution by the processor, further cause the processor to at least:
receive user feedback in response to automatically moving the icon representing the entity identifier to the portion of the GUI associated with the proposed entity class; and
train the entity classifier model using the received user feedback.
